(19) United States
(12) Patent Application Publication
(10) Pub. No.: US 2004/0134978 A1
(43) Pub. Date: Jul. 15, 2004

(54) Image data input/output apparatus in which an item of stored image data can be selected using a check sheet indicating thumbnails thereof

(76) Inventors: Junichi Hara, Kanagawa (JP); Toshio Miyazawa, Kanagawa (JP); Yasuyuki Nomizu, Kanagawa (JP); Hiroyuki Sakuyama, Tokyo (JP); Nekka Matsuura, Kanagawa (JP); Takanori Yano, Kanagawa (JP); Taku Kodama, Kanagawa (JP); Yasuyuki Shinkai, Kanagawa (JP); Takayuki Nishimura, Tottori (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/682,121

(22) Filed: Oct. 10, 2003

(30) Foreign Application Priority Data
Oct. 11, 2002 (JP) 2002-298432

(51) Int. Cl. G06F 17/00

(52) U.S. Cl. 235/375

(57) ABSTRACT

An image data input/output apparatus is disclosed that includes a scanner, a printer, and a storage unit. In addition, a check sheet forming unit forms a check sheet by compositing thumbnails corresponding to items of image data stored in the storage unit and causes the printer to print the formed check sheet. Further, a selected image recognition unit causes the scanner to scan the printed check sheet and recognize the selected thumbnails, and a selected image output unit retrieves the items of image data corresponding to the selected thumbnails and outputs the retrieved items of image data. A user can print the check sheet indicating the thumbnails, and can select one or more thumbnails by indicating a check mark. The image data input/output apparatus scans the check sheet and recognizes the scanned check marks. Accordingly, the user can easily output the items of image data corresponding to the selected thumbnails.

### BACKGROUND OF THE INVENTION

1. Field of the Invention

The present invention generally relates to an image data input/output apparatus such as a multifunctional peripheral (MFP), a method of selecting an item of image data stored in the image data input/output apparatus, a computer program that causes a computer to function as the image data input/output apparatus, and a computer readable recording medium storing the computer program.

2. Description of the Related Art

Technologies for inputting and outputting images are being rapidly improved. In the field of copiers, for example, the migration from analog copiers to digital copiers has realized various image processing improvements. The digital copiers are evolving into so-called multifunctional peripherals (MFP) having printer function, facsimile function, and e-mail function, for example.

The MFPs often use an image compression technique such as JPEG 2000 in order to reduce the size of images and save memory provided therein. When an image is scanned by a scanner, for example, the scanner generates image data. The generated image data is encoded for compressing into code data. The code data is stored in the memory. When the stored code data is output, the code data is retrieved from the memory, and is decoded for decompressing. The decoded image data is output to a printer, for example.

If a user does not need the image data now but needs it later, the image data may be temporarily held in the memory.

The MFP may become an image database system with a large storage capacity. When copying a document or transmitting a document via facsimile, a user may acquire image data of the document with the scanner and accumulate the acquired image data in the storage unit so that the user can reproduce the image data later.

In the case that image data is accumulated in an image database stored in the storage unit of the MFP, there is a question of how the user is to select image data in the storage unit that the user desires to output.

Although a computer is usually provided with a keyboard and a display, for example, the MFP may be provided with a small operations panel such as an LCD touch panel. The operations panel of the MFP is too small to show items of image data, even their thumbnails.

If the MFP is connected to a computer via a network, a user may be able to access the image data stored in the storage unit of the MFP by operating the computer. The user accessing the image data can display the thumbnails of image data on a display (a CRT and/or an LCD, for example), and select an item of image data that the user desires to output to the printer, for example, by pressing the thumbnail of the selected item of image data.

However, if the MFP is not connected to the computer via the network, the user cannot easily select the item of image data. Likewise, if the user is not accustomed to using the computer, the user may prefer selecting the item of image data in the same manner as operating a home electronic appliance. Additionally, if the user needs to view a hundred items of image data, for example, the transmission of a hundred thumbnails from the MFP to the computer takes a long time.

### SUMMARY OF THE INVENTION

Accordingly, it is a general object of the present invention to provide a novel and useful image data input/output apparatus in which one or more of the problems described above are eliminated.

Another and more specific object of the present invention is to provide an image data input/output apparatus in which an item of image data stored in the storage unit can be selected in the same manner as operating a home electronic appliance.

To achieve at least one of the above objects, an image data input/output apparatus, according to the present invention, includes: a scanner; a printer; a storage unit that stores one or more items of image data; a check sheet forming unit that forms a check sheet by compositing thumbnails corresponding to the items of image data stored in said storage unit and causes said printer to print the check sheet; a selected image recognition unit that causes said scanner to scan the check sheet printed by said printer, and recognizes the thumbnails selected by checking the thumbnails composited in the scanned check sheet; and a selected image output unit that retrieves the items of image data corresponding to the thumbnails selected by checking, and outputs the retrieved items of image data.

According to the above arrangement, a user can print the check sheet indicating the thumbnails corresponding to items of image data stored in the storage unit, and can select one or more thumbnails by checking them. The image data input/output apparatus can scan the check sheet with the scanner and can recognize the scanned check sheet with the selected image recognition unit. Accordingly, the user can output the items of image data corresponding to the selected thumbnails easily, like operating a home electronic appliance.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram showing a communication system in which an MFP according to a first embodiment is provided;

FIG. 2 is a block diagram showing the hardware structure of the MFP according to the first embodiment;

FIG. 3 is a block diagram for explaining the JPEG 2000 algorithm;

FIG. 4 is a schematic diagram for explaining sub-bands of decomposition levels 0 through 3;

FIG. 5 is a flow chart showing processing for outputting a check sheet for selecting images according to the first embodiment;

FIGS. 6A and 6B illustrate an exemplary check sheet for selecting images before and after checking, respectively, according to the first embodiment;

FIG. 7 is a flow chart showing processing for outputting selected images according to the first embodiment;

FIG. 8A illustrates an exemplary check sheet for selecting images before checking according to a second embodiment;

FIGS. 8B through 8D illustrate an exemplary check sheet for selecting images after checking according to the second embodiment; and

FIG. 9 is a flow chart showing processing for outputting selected images according to the second embodiment.

### DETAILED DESCRIPTION OF THE PREFERRED EMBODIMENTS

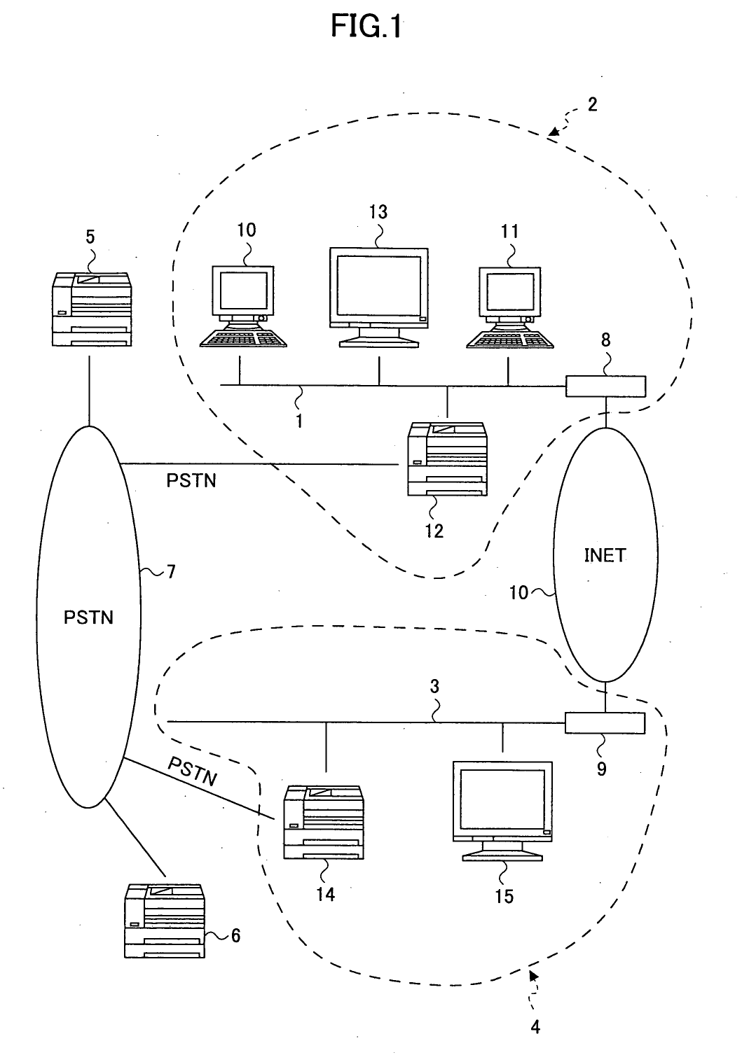

A first embodiment of the present invention is described with reference to FIGS. 1 through 7. An image data input/output apparatus according to the first embodiment is a multifunctional peripheral (MFP), for example. The MFP functions as an Internet facsimile apparatus, and is used in a system as shown in FIG. 1.

FIG. 1 is a schematic diagram for explaining the system. The system is configured by the following: a domain 2 including a local area network (LAN) 1, a domain 4 including a LAN 3, and facsimile apparatuses 5 and 6. The domains 2 and 4 are connected to service providers of the Internet 10 by routers 8 and 9, respectively, and via leased channels. The facsimile apparatuses 5 and 6 are G3 facsimile apparatuses that are connected to a public switched telephone network (PSTN) 7.

The domain 2 is provided with the router 8, computers 10 and 11, an MFP 12, and a mail server 13. The MFP 12 can function as an Internet facsimile. The mail server 13 provides the computers 10 and 11 and the MFP 12 with electronic mail services. The computers 10 and 11, the MFP 12, and the mail server 13 may be referred to as “terminals”. Each terminal 10-13 has a unique host address that is a combination of the network address of the domain 2 and a unique address of the terminal 10-13. A user using the computer 10 or 11 is identified by a user address that is a combination of the user's unique address name and the host address of the computer 10 or 11.

The domain 4 is provided with an MFP 14 and a mail server 15. The MFP 14 can function as an Internet facsimile. The mail server 15 provides the MFP 14 with electronic mail services. The MFP 14 and the mail server 15 may be also referred to as “terminals”.

The MFPs 12 and 14 can exchange an item of image data as an e-mail via the LAN 1 and 3. The MFPs 12 and 14 can also exchange an item of image data as a facsimile message via the PSTN 7 in compliance with the group 3 transmission protocol.

The terminals exchange general data including image data via the LAN 1, 3 and/or the Internet in compliance with a so called protocol suite that is a combination of transmission protocols up to the transport layer (TCP/IP) and upper rank transmission protocols above the transport layer. For example, e-mails are transmitted using an upper rank transmission protocol such as the Simple Mail Transfer Protocol (SMTP).

According to the first embodiment, in the case in which an e-mail is sent by the computer 10 provided in the domain 2, for example, the e-mail is temporarily stored in the mail server 13, and then, delivered to the terminals of which addresses are designated in the e-mail. The system may be referred to as a “store and deliver” type system. If the e-mail includes the network address of the domain 2, the e-mail remains stored in the mail server 13 until the addressed terminal fetches the e-mail stored in the mail server 13. If the e-mail includes the network address of the domain 4, for example, the e-mail is transferred to the mail server 15 via the router 8, the Internet, and the router 9, and is stored in the mail server 15 until the addressed terminal in the domain 4 fetches the e-mail.

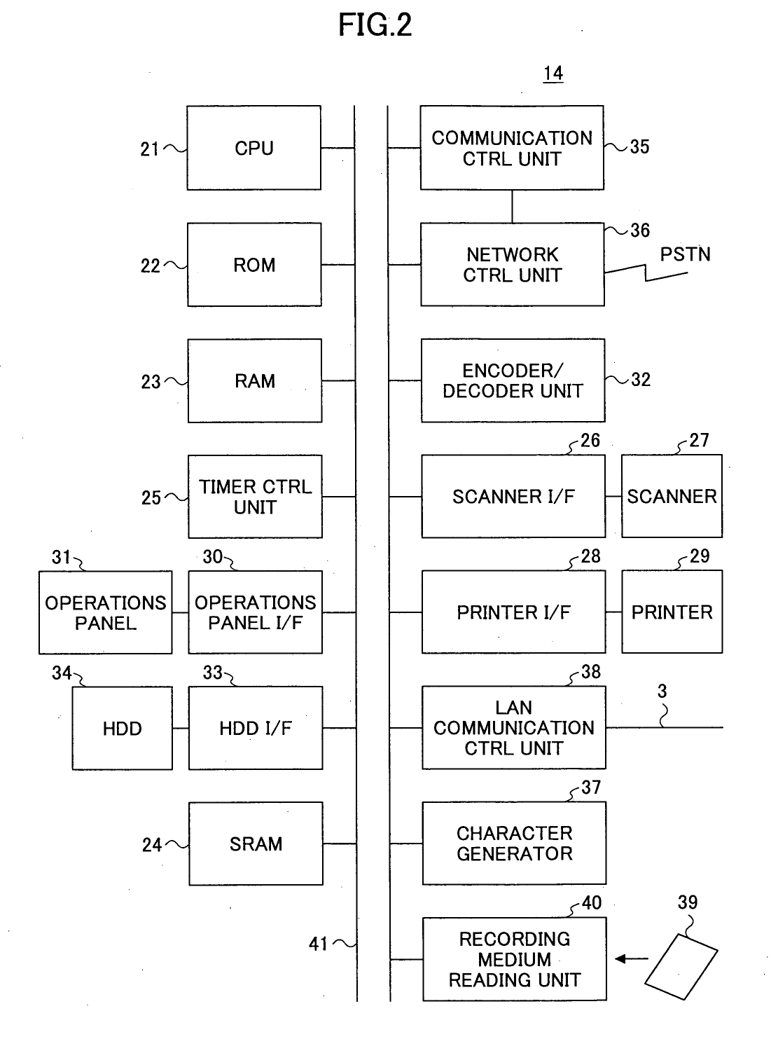

The MFP 14 is provided in the domain 4 where no computer with which a user can access the MFP 14 is provided. Accordingly, the MFP 14 is focused on and is described in detail below. FIG. 2 is a block diagram showing the hardware structure of the MFP 14 according to the first embodiment.

The MFP 14 is provided with CPU 21, ROM 22, and RAM 23 constituting a system control unit as a general purpose personal computer. The system control unit controls remaining portions of the MFP 14 and performs various processing such as facsimile transmission control protocol. The ROM 22 stores various computer programs that are executed by the CPU 21. The ROM 22 also stores various data that the CPU executing the computer programs needs to access. The RAM 23 is used as a working memory by the CPU 21.

The MFP 14 is further provided with SRAM 24 and a timer control unit 25. The SRAM 24 is battery backed up. Even when the power of the MFP 14 is turned off, the SRAM 24 retains data. The timer control unit 25 measures current time.

The MFP 14 is further provided with a scanner interface (I/F) 26, a scanner 27, a printer interface (I/F) 28, a printer 29, an operations panel interface (I/F) 30, and an operations panel 31. The scanner I/F 26 interfaces the scanner 27 that reads documents at a predetermined resolution. The printer I/F 28 interfaces the printer 29 that prints image data at a predetermined resolution. The operations panel I/F 30 interfaces the operations panel 31 including various operational keys and displays through which users can operate the MFP 14.

The MFP 14 is further provided with an encoder/decoder unit 32 that encodes image data into code data for compressing, and decodes the code data into image data for decompressing. The compression algorithm used by the encoder/decoder unit 32 is JPEG 2000, for example.

The MFP 14 is further provided with a hard disk drive interface (HDD I/F) 33 and a hard disk drive (HDD) 34. The HDD I/F 33 interfaces the HDD 34 that stores encoded image data (code data).

The MFP 14 is further provided with a communication control (CNTL) unit 35 and a network control unit 36. The communication control unit 35 realizes modem functions for group 3 facsimile, specifically a low speed modem function for exchanging transmission control procedures and a high speed modem function for mainly exchanging image data. The network control unit 36 connects the MFP 14 to the PSTN 7. The network control unit 36 can automatically make and receive calls. As shown in FIG. 2, the communication control unit 35 and the network control unit 36 directly exchange data.

The MFP 14 is further provided with a character generator 37, a LAN communication control unit 38, and a recording medium reading unit 40. The character generator 37 stores character fonts. The LAN communication control unit 38 is unique to the MFP 14. The LAN communication control unit 38 supports LAN 3 such as an Ethernet (trade mark) LAN as the physical layer. The LAN communication control unit 38 handles TCP/IP protocols and the Multipurpose Internet Mail Extension (MIME) conversion of e-mails. The recording medium reading unit 40 reads computer programs from a recording medium 39 and stores the read computer programs in the RAM 23, for example. The recording medium reading unit 40 is an IC card reader, for example, provided with an insertion slot for an IC card.

All the above elements provided to the MFP 14, except for the scanner 27, the printer 29, the operations panel 31, and the HDD 34 connected to respective interfaces, are connected to an internal bus 41 through which data are exchanged.

The encoder/decoder unit 32 uses the JPEG 2000 algorithm. Only the outline of the JPEG 2000 algorithm is described below. A detailed description of JPEG 2000 is available in various laid-open patent applications and documents such as the International Standard, ITU-T recommendation T.800 (2000 FCD 154441 V1.0), the entire contents of which are hereby incorporated by reference.

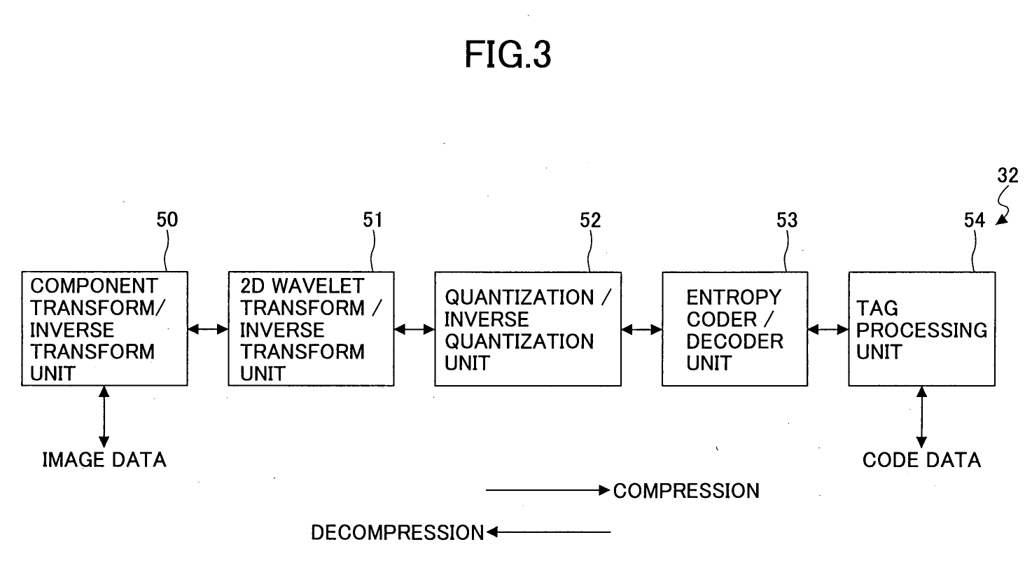

FIG. 3 is a block diagram showing an encoder/decoder system 32 that realizes the JPEG 2000 algorithm. The JPEG 2000 system is structured by a component transform/inverse transform unit 50, a 2 dimensional wavelet transform/inverse transform unit 51, a quantization/inverse quantization unit 52, an entropy encoder/decoder unit 53, and a tag processing unit 54.

JPEG 2000 is characterized by the use of 2 dimensional Discrete Wavelet Transform (DWT) that realizes, even in high compression regions, better image quality than conventional JPEG systems do. JPEG 2000 is further characterized by the addition of the tag processing unit 54 to the final stage of the encoding process/first stage of the decoding process. The tag processing unit 54 generates and interprets codestreams. For example, the JPEG 2000 system can stop encoding or decoding processing at any layer corresponding to a decomposition level.

The component transform/inverse transform unit 50 is often provided at the first stage of the encoding process. The component transform/inverse transform unit 50 converts image data represented in the R(Red)/G(Green)/B(Blue) color space or the Y(Yellow)/M(Magenta)/C(Cyan) color space into image data represented in the YCrCb color space or the YUV color space, or vice versa.

The JPEG 2000 algorithm, especially the discrete wavelet transform, is described below.

In the encoding process, image data of each tile is input to the component transform unit 50 in which the color space of the image data is transformed. After the component transformation, the image data is transformed with 2-dimensional wavelet transform (forward transform) by the 2-dimensional wavelet transform unit 51. Accordingly, the image data is divided into wavelets of various frequencies.

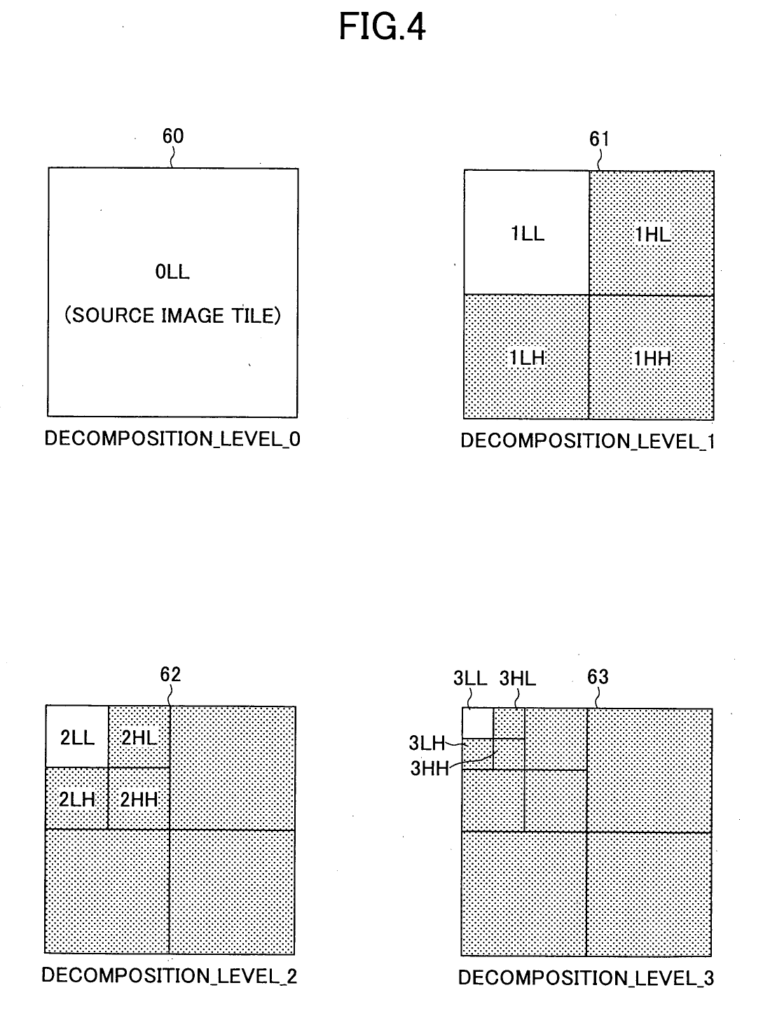

FIG. 4 is a schematic diagram showing sub-bands of each decomposition level up to the decomposition level 3. A source image tile 0LL of the decomposition level 0 denoted by a reference numeral 60 is transformed with the 2-dimensional wavelet transform, and is divided into sub-bands 1LL, 1HL, 1LH, and 1HH of the decomposition level 1 denoted by a reference numeral 61. The low frequency component 1LL of the decomposition level 1 is transformed with the 2-dimensional wavelet transform, and is divided into sub-bands 2LL, 2HL, 2LH, and 2HH of the decomposition level 2 denoted by a reference numeral 62. Then, the low frequency component 2LL of the decomposition level 2 is transformed with the 2 dimensional wavelet transform, and is divided into sub-bands 3LL, 3HL, 3LH, and 3HH of the decomposition level 3 denoted by a reference numeral 63.

In FIG. 4, the sub-bands that are encoded in each decomposition level are shaded. For example, in the decomposition level 3, the shaded sub-bands 3HL, 3LH, 3HH, 2HL, 2LH, 2HH, 1HL, 1LH, and 1HH are encoded, but the sub-band 3LL is not encoded.

Bits are encoded in a designated order. The quantization unit 52 forms a context based on bits around (in the vicinity of) the bits to be encoded. After quantization, wavelet coefficients are divided into non-overlapping rectangular regions called precincts by each sub-band. The wavelet coefficients may be quantized and encoded without dividing into precincts. However, in order to increase the efficiency of encoding, the wavelet coefficients may be divided by bit planes, and the bit planes may be prioritized by pixels or code-blocks.

The entropy encoder unit 53 encodes tiles of each component based on probability estimates using the context and the bits to be encoded. All components of the source image are encoded by a tile as described above. The tag processing unit 5 combines all code data encoded by the entropy encoder unit 53 into a codestream, and attaches tags thereto.

Likewise, image data is reproduced from codestreams of each tile of each component in the decoding process. In this case, the tag processing unit 54 interprets tags attached to a codestream input thereto, and decomposites the codestream into codestreams corresponding to each of the tiles of each component. The codestreams corresponding to each tile of each component are decoded. The positions of bits to be decoded are determined based on the order indicated in the tags. The inverse quantization unit 52 generates a context based on a series of decoded bits around the bits to be decoded. The entropy decoder unit 53 decodes the bits with probability estimates based on the context and the codestream. The decoded bits are written in the determined position.

The decoded data is still spatially divided by frequency bands. Each tile of each component of the image data is reproduced by transforming the decoded data with 2-dimensional wavelet inverse transform by the 2-dimensional wavelet inverse transform unit 51. The component inverse transform unit 50 transforms the reproduced image data into its original color space.

As is apparent from the above description with reference to FIG. 4, the low frequency sub-bands 2LL and 3LL, for example, can represent ¼ and ⅛ shrunk images (thumbnails), respectively, of the source image. In other words, the thumbnail is a part of the source image.

When the MFP 14 reads a document with the scanner 27, the MFP 14 converts the read image data of the document into code data in compliance with the JPEG 2000 algorithm, and stores the converted code data in the HDD 34. According to such an arrangement, the MFP 14 may build an image database. The MFP 14 may store not only the converted code data but also image data transmitted by the facsimile apparatuses 5, 6 and the MFP 12, for example. As a result, the MFP 14 can accumulate a large amount of image data in the HDD 34. Each item of the image data stored in the HDD 34 as a file is controlled using the date of registration and a destination address, for example.

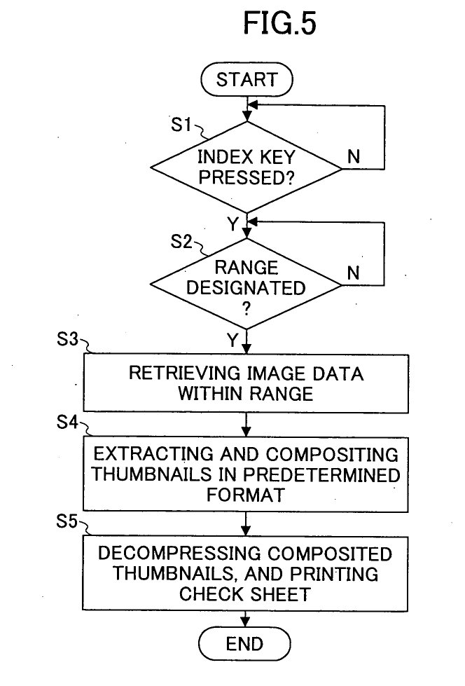

The MFP 14 according to a first embodiment of the present invention makes it easy to select a desired item of image data stored in the image database in the HDD 34 using a check sheet. The scanner 27 according to the first embodiment has an Optical Character Recognition (OCR) function. Referring to FIGS. 5 through 7, processing by the CPU 21 is described below.

A determination is made whether a user presses an index key (not shown) provided in the operations panel 31 (step S1). If the determination is “yes”, a determination is made whether a range of items of image data is designated by designating a period in which the items of image data that a user desires to output are registered, for example (step 2). If the determination is “yes”, the items of image data within the designated range are retrieved from the HDD 34 to the RAM 23 (step S3). The retrieved items of image data are code data encoded in compliance with JPEG 2000. The 3LL sub-band, for example, is extracted from each item of image data as a thumbnail. The thumbnails are composited in a predetermined format (step S4). For example, every 8 thumbnails may be composited on a sheet of A4 size paper forming 2 rows×4 columns equally distant from one another. The composited thumbnails are decompressed with the encoder/decoder unit 32, and printed with the printer 29 (step S5). The sheet of paper on which the composited thumbnails are indicated is referred to as a check sheet. If there are more than 8 items of image data, for example, in the designated range, the thumbnails of the image data may be composited on multiple check sheets.

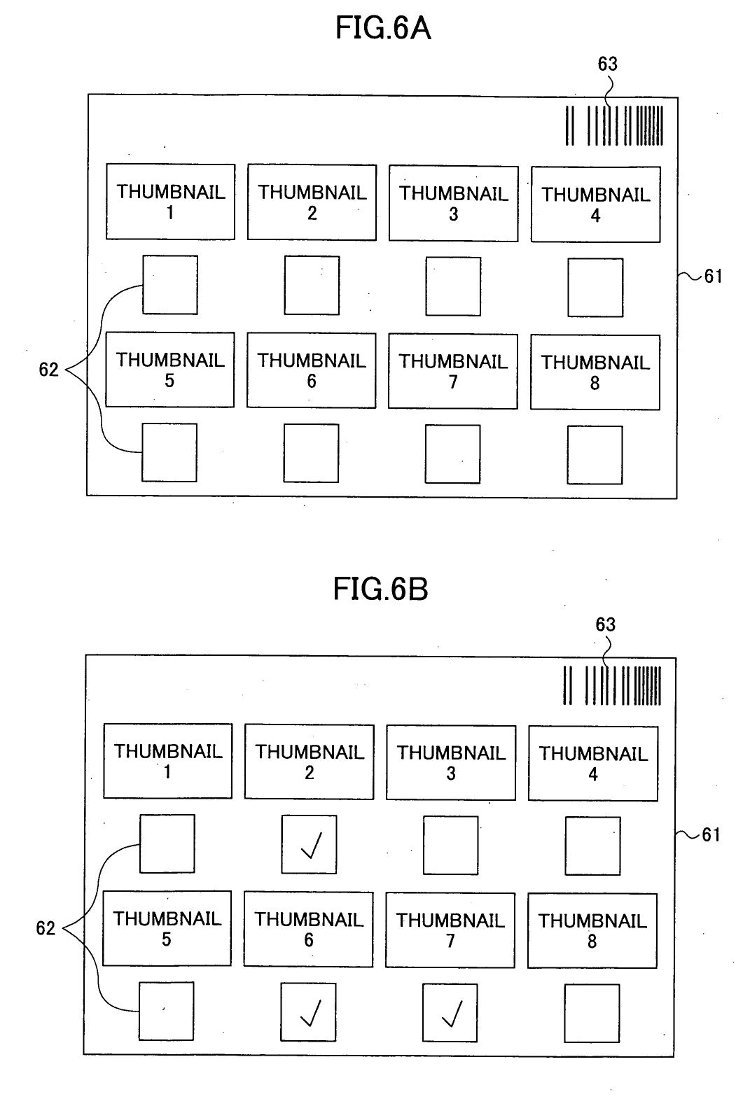

According to the above arrangement, the composited thumbnails are indicated on a check sheet 61 as shown in FIG. 6A. Thumbnails 1 through 8 are shown in FIG. 6A. It is noted that a check box 62 is provided for each thumbnail 1 through 8. A user can select one or more of the thumbnails shown in the check sheet 61 by checking (placing a check-mark in) the check box. It is also noted that there may be a bar code 63 printed on the check sheet 61. The bar code 63 may indicate that the sheet of paper is a check sheet. The bar code 63 may also indicate the relationship between the composited thumbnails and the items of image data stored in the RAM 13 or the HDD 34, for example.

Looking at the composited thumbnails on the check sheet 61, the user can select a thumbnail of image data that the user desires to output by checking a corresponding check box. FIG. 6B shows an exemplary check sheet 61 in which thumbnails 2, 6, and 7, for example, are selected by checking the corresponding check boxes. Since the check sheet 61 is a sheet of A4 paper, for example, and is usually larger than the screen size of the operations panel 31 (FIG. 2), the user can visually recognize the thumbnails 1 through 8. Accordingly, the user can easily select the items of image data that the user desires to output.

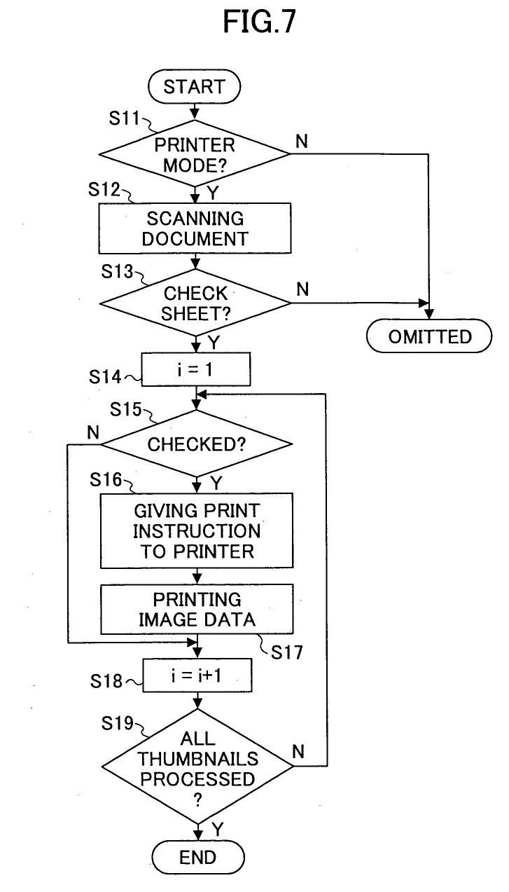

Referring to FIG. 7, output processing of the selected items of image data is described below. An assumption is made that the user desires to print the selected items of image data with the printer 29, and a print mode is selected.

A determination is made whether the print mode is set (step S11). If the determination is “yes”, when a document is set on the scanner 27, the scanner 27 scans the document (step S12). Subsequently, a determination is made whether the document is a check sheet 61 by reading the bar code 63, if any (step S13). If there is a bar code 63 on the scanned document, and a determination that the document is the check sheet 61 (“yes” in step S13), a parameter i indexing the thumbnails 1 through 8 and corresponding check boxes 62 is set at 1 (step S14). Then, a determination is made whether there is a check mark in the check box of which parameter i=1 (step S15). If there is a check mark in the check box 62 (“yes” in step S15), the process gives an instruction to the printer 29 in order to print the item of image data corresponding to the thumbnail of which the parameter i=1 (step S16). The selected item of image data is decompressed by the encoder/decoder unit 32 (FIG. 2). The printer 29, in response to receipt of the instruction from the process, acquires and prints the decompressed item of image data. If there is no check mark in the check box 62 (“no” in step S15), steps S16 and S17 are skipped.

Subsequently, the parameter i is incremented by 1 (step S18), and steps S15 through S18 are repeated for the remaining thumbnails and check boxes 62 (steps S15 through S18). When all the check boxes 62 on the check sheet 61 are processed (step S19), the process ends.

According to another embodiment, the selected items of image data may be output to the facsimile apparatuses 5, 6, and 12 via the PSTN 7 by designating their phone numbers, for example. The selected items of image data may also be output to the computers 10 and 11 via the Internet 10 by designating their e-mail addresses, for example.

As described above, the user can print the check sheet 61 and select the item of image data that the user desires to output by indicating a check mark with a pen, for example, in the check box 62 provided for each thumbnail of the items of image data. After indicating a check mark, the user may scan the check sheet 61 with the scanner 27. The MFP 14 recognizes and outputs the selected thumbnail. According to the above arrangement, the user can select an item of image data from the image database stored in the MFP 14, and can output the selected item of image data as if the user is operating a home electronic appliance.

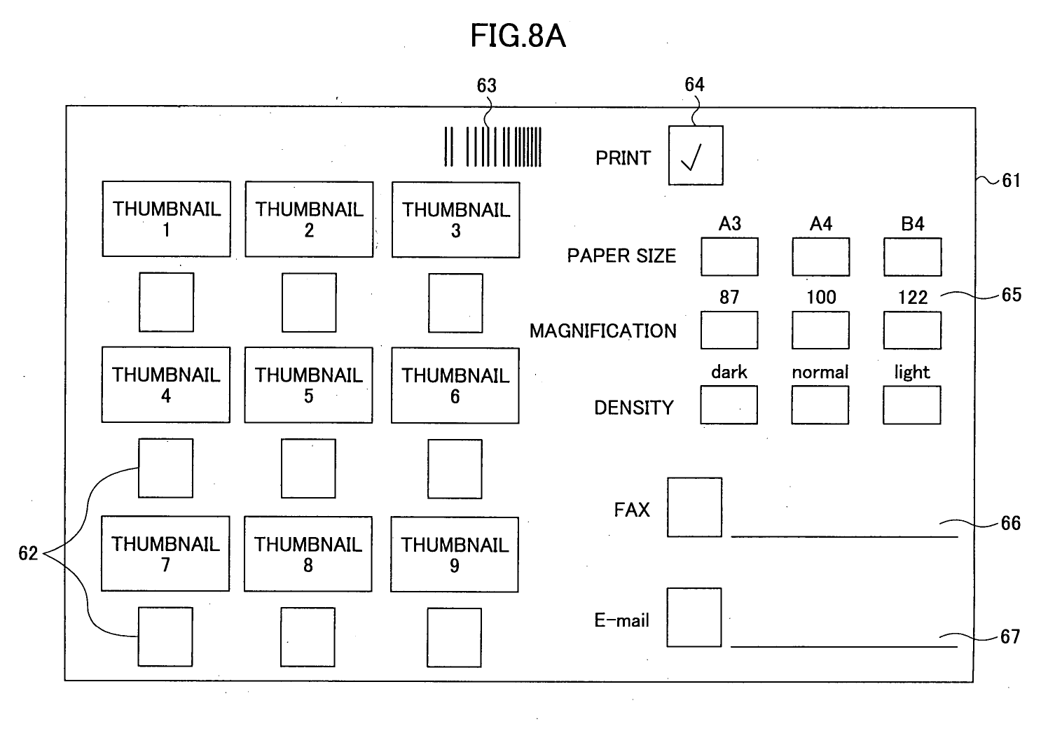

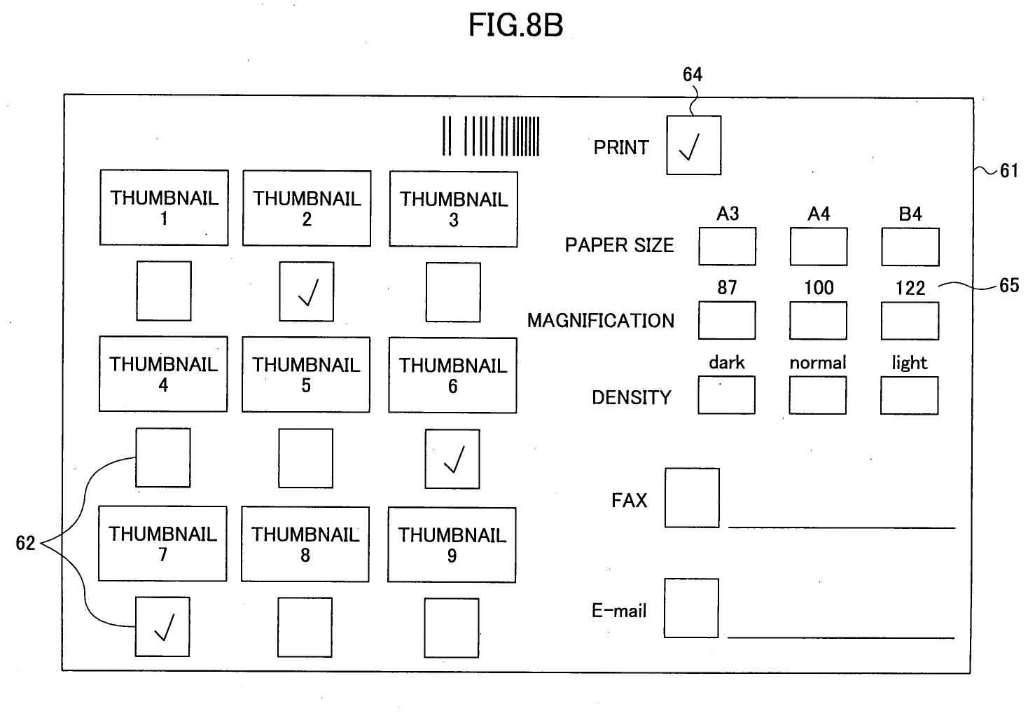

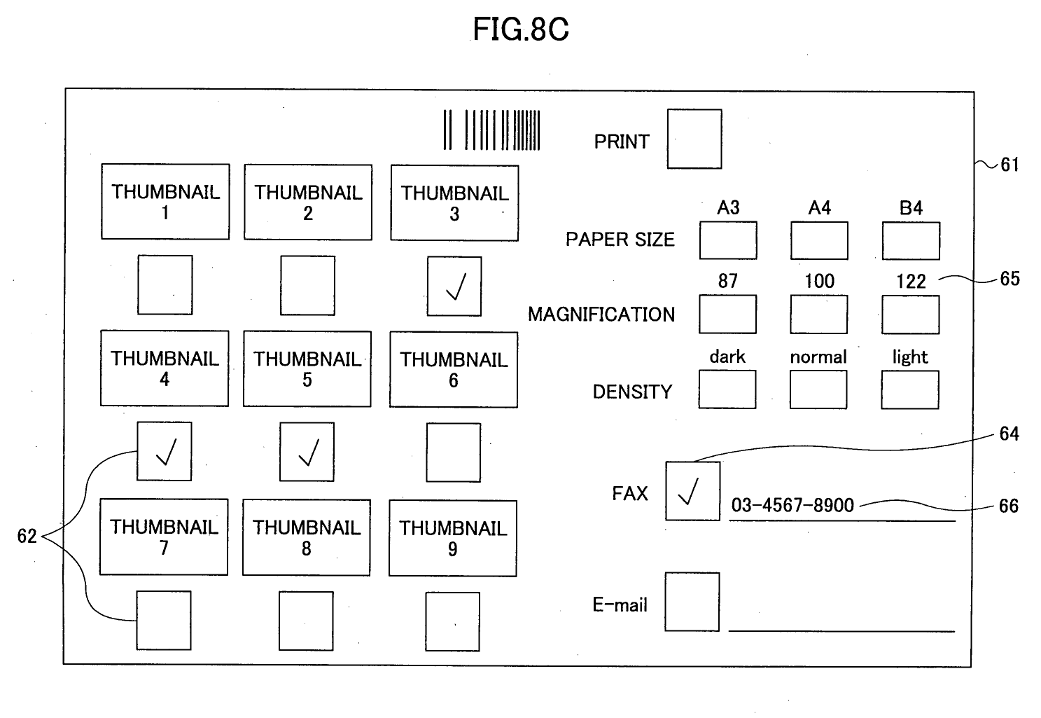

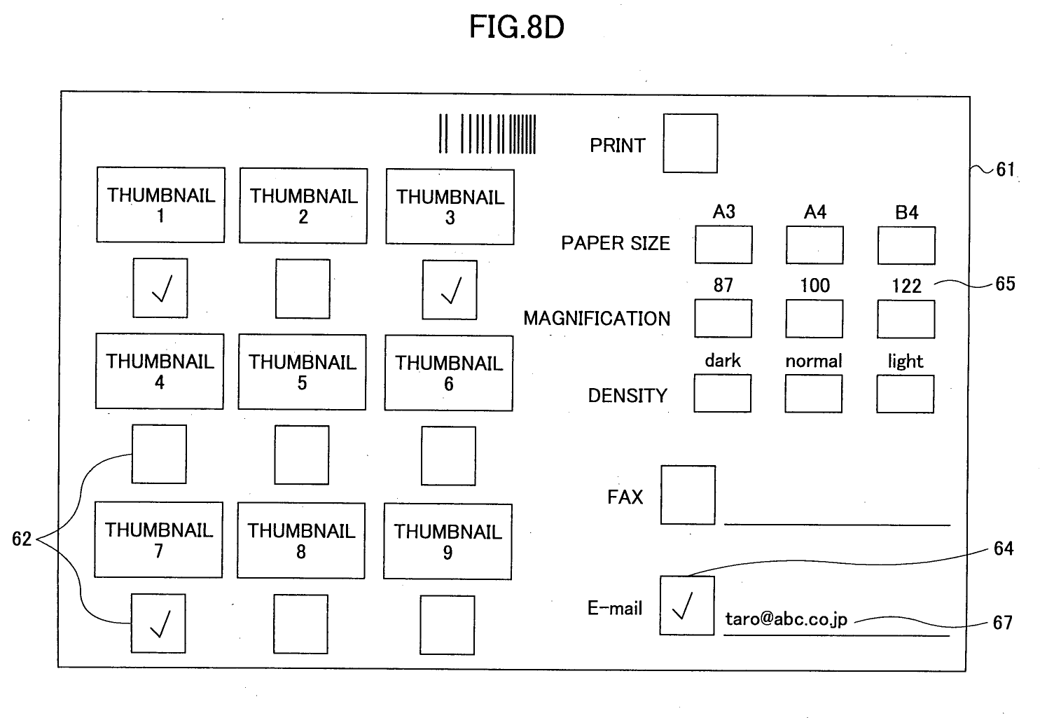

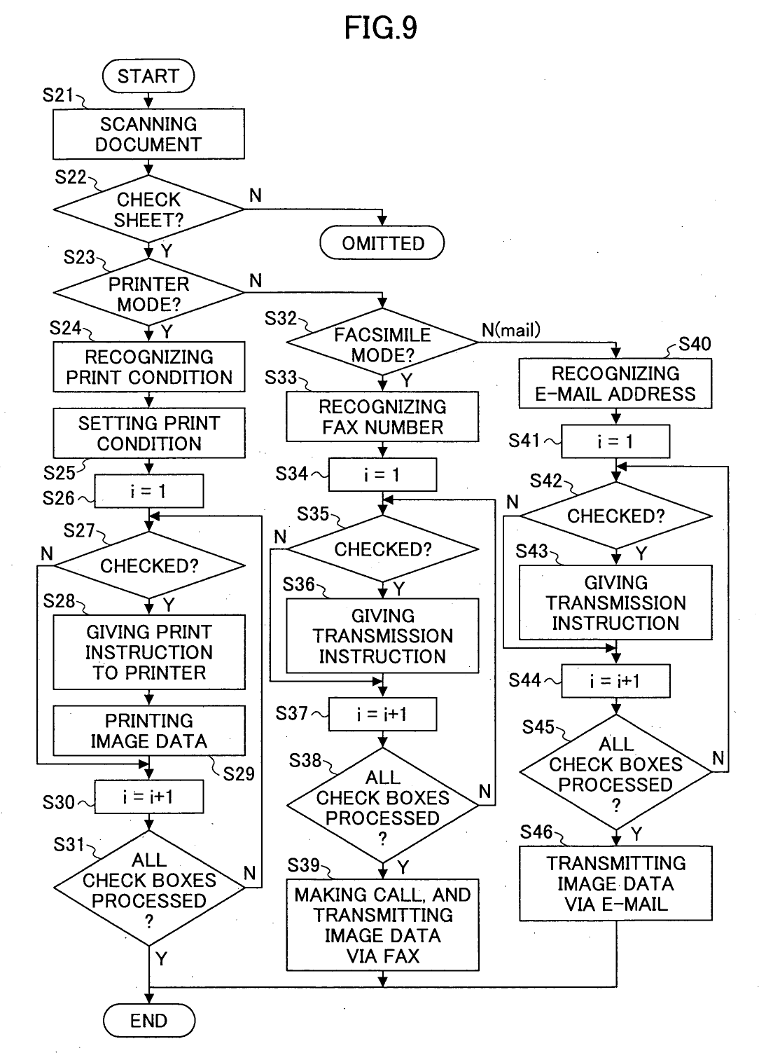

A second embodiment of the present invention is described with reference to FIGS. 8 and 9. Elements identical to those of the first embodiment are referred to by the same reference numerals, and their description is omitted. A check sheet 61 according to the second embodiment includes additional check boxes and input boxes. FIG. 8A shows an exemplary check sheet 61 according to the second embodiment. For example, the check sheet 61 includes mode check boxes 64 for selecting either a printer mode, a facsimile mode, or an e-mail mode. The check sheet 61 further includes check boxes 65 for designating print conditions such as paper size, magnification, and print density, for example, for the printer mode. The check sheet 61 also includes a facsimile number input box 66 for the facsimile mode, and an e-mail address input box 67 for the e-mail mode.

When a user desires to output some items of image data stored in the image database of the MFP 14, the user prints the check sheet 61 as shown in FIG. 8A. If the user desires to print the image data, the user can select one or more thumbnails by indicating check marks in respective check boxes 62, the printer mode by indicating a check mark in the print mode check box 64, and the print condition check boxes 65 as shown in FIG. 8B. If the user desires to transmit the image data via facsimile, the user can select one or more thumbnails by indicating check marks in respective check boxes 62, the facsimile mode by indicating a check mark in the facsimile mode check box 64, and write a facsimile number in the input box 66 as shown in FIG. 8C. If the user desires to transmit the image data as an e-mail, the user can select one or more thumbnails by indicating check marks in respective check boxes 62, the e-mail mode by indicating a check mark in the e-mail mode check box 64, and write an e-mail address in the input box 67 as shown in FIG. 8D.

Referring to FIG. 9, output processing using the check sheet 61 is described below.

When a document is set on the scanner 27, the document is scanned by the scanner 27 (step S21). Subsequent to step S21, a determination is made whether there is a bar code 63 on the scanned document, and whether the scanned document is a check sheet 61 (step S22). If a determination is made that the scanned document is a check sheet 61 (“yes” in step S22), a determination is made whether the printer mode check box 64 is checked (step S23). If the printer mode check box 64 is checked (“yes” in step S23), the print conditions indicated by the print condition check boxes 65 are recognized (step S24). The recognized print conditions are set to the printer 29 (step S25). Subsequent to step S25, an index number i indexing the thumbnails and corresponding check boxes 62 is set at 1 (step S26). The process determines whether a check mark is indicated in the check box 62 of which index number i=1 (step S27). If the check box 62 is checked (“yes” in step S27), the process gives an instruction to the printer 29 to output the item of image data corresponding to the thumbnail of which the index number i=1 (step S28). In response to receipt of the instruction, the printer 29 acquires the image data decompressed by the encoder/decoder unit 32, and prints the decompressed image data in compliance with the print condition (step S29). Then, the process increment the index number i by 1 (step S30). If the check box 62 of which index number i=1 is not checked (“no” in step S27), the process increment the index number i by 1 (step S30) without performing steps S28 and S29. Steps S27 through S30 are repeated for the remaining check boxes 62 until all the check boxes 62 on the check sheet 61 are processed (step S31). When all the check boxes 62 are processed, the process ends.

Meanwhile, if the printer mode check box 64 is not checked (“no” in step S23), a determination is made whether the facsimile mode check box 64 is checked (step S32). If the facsimile mode check box 64 is checked (“yes” in step S32), the facsimile number written in the facsimile number input box 66 is recognized by the Optical Character Recognition (OCR) function (step S33). Then, the index number i of the thumbnails and the corresponding check boxes is set at 1 (step S34). A determination is made whether the check box 62 of which the index number i=1 is checked (step S35). If the check box 62 is checked (“yes” in step S35), the process gives an instruction to the communication control unit 35 to transmit the image data corresponding to the thumbnail i=1 (step S36). If the check box 62 is not checked (“no” in step S35), step S36 is skipped. Subsequently, the process increments the index number by 1 (step S37). Then, steps S35 through S37 are repeated for the remaining check boxes 62 and thumbnails. When all check boxes 62 on the check sheet 61 are processed (“yes” in step S38), a call is made to a facsimile number written on the check sheet that is recognized by the OCR function, and the image data, that is, the code data, is transmitted to a facsimile apparatus (step S39). Then, the process ends.

If there is no check mark in the facsimile mode check box 64 (“no” in step S32), it is determined that the e-mail mode check box 64 is checked. The e-mail address written in the e-mail address input box 67 is recognized with the OCR function (step S40). The index of the check box 62 is set at 1 (step S41), and a determination is made whether there is a check mark in the check box 62 of which the index number is i=1. If the determination is “yes” (“yes” in step S42), an instruction is given to the LAN communication control unit 38 to transmit the image data corresponding to the thumbnail of which the index number i=1 (step S43). Then, the index number i is incremented by 1 (step S44). If the check box 62 of which the index number is i=1 is not checked (“no” in step S42), step S43 is skipped, and the index number i is incremented by 1 (step S44). Steps S42 through S44 are repeated for the remaining check boxes 62. When all check boxes 62 in the check sheet 61 are processed (“yes” in step S45), the code data of the items of image data that are designated by writing the check mark in the check box 62 is transmitted to a computer of which e-mail address is written in the input box 67 (step S46). Then, the process ends.

As described above, it is possible to select items of image data using the check sheet 61. The check sheet 61 also enables users, in the case of printing the selected items of image data, to set the print condition by checking corresponding check boxes 65. In the case of transmitting the selected items of image data via facsimile or e-mail, the facsimile number or the e-mail address can be input by writing them in the corresponding input boxes 66 or 67, respectively. The users can operate the MFP 14 easily, like operating a home electric appliance.

According to the above embodiments, the image data are encoded into code data in compliance with the JPEG 2000 algorithm, and the encoded code data corresponding to the image data are stored. According to another embodiment of the present invention, the image data may be encoded in compliance with the JPEG algorithm. In the case where image data are encoded with the JPEG algorithm, the thumbnail of the image data may be retained in a file separate from the image data.

The present invention is not limited to these embodiments, but various variations and modifications may be made without departing from the scope of the present invention.

This patent application is based on

Japanese Priority Patent Application No. 2002-298432 filed on Oct. 11, 2002, the entire contents of which are hereby incorporated by reference.

What is claimed is:

1. An image data input/output apparatus, comprising:
a scanner;
a printer;
a storage unit that stores one or more items of image data;
a check sheet forming unit that forms a check sheet by compositing thumbnails corresponding to the items of image data stored in said storage unit and causes said printer to print the check sheet;
a selected image recognition unit that causes said scanner to scan the check sheet printed by said printer, and recognizes the thumbnails selected by checking the thumbnails composited in the scanned check sheet; and
a selected image output unit that retrieves the items of image data corresponding to the thumbnails selected by checking, and outputs the retrieved items of image data.

2. The image data input/output apparatus as claimed in claim 1, further comprising an encoding unit that encodes for compressing the items of image data in compliance with JPEG 2000 algorithm, and stores the encoded items of image data in said storage unit.

3. The image data input/output apparatus as claimed in claim 1, wherein said selected image output unit outputs the retrieved items of image data to said printer.

4. The image data input/output apparatus as claimed in claim 3, wherein
said check sheet forming unit forms the check sheet in which a printing condition can be designated;
said selected image recognition unit recognizes the designated printing condition; and
said selected image output unit designates the printing condition to said printer.

5. The image data input/output apparatus as claimed in claim 1, wherein said selected image output unit outputs the retrieved items of image data to a facsimile apparatus connected to the image data input/output apparatus via a communication interface and a channel.

6. The image data input/output apparatus as claimed in claim 5, wherein
said check sheet forming unit forms the check sheet in which address information of said facsimile apparatus can be designated;
said selected image recognition unit recognizes the designated address information; and
said selected image output unit makes a call based on the recognized address information to said facsimile apparatus.

7. The image data input/output apparatus as claimed in claim 1, wherein said selected image output unit outputs the retrieved items of image data to a terminal connected to the image data input/output apparatus via a communication interface and a network.

8. The image data input/output apparatus as claimed in claim 7, wherein
said check sheet forming unit forms the check sheet in which address information of said terminal can be designated;
said selected image recognition unit recognizes the designated address information; and
said selected image output unit makes a call based on the recognized address information to said terminal.

9. A method of outputting an item of image data, comprising the steps of:
forming a check sheet by compositing thumbnails corresponding to a plurality of the items of image data;
printing the formed check sheet;
scanning the printed check sheet;
recognizing the thumbnail that is selected by checking;
retrieving the item of image data corresponding to the selected thumbnail; and
outputting the retrieved item of image data.

10. A computer program that causes a computer having a scanner, a printer, and a storage unit that stores one or more items of image data, to function as:
a check sheet forming unit that forms a check sheet by compositing thumbnails corresponding to the items of image data stored in said storage unit and causes said printer to print the check sheet;
a selected image recognition unit that causes said scanner to scan the check sheet printed by said printer, and recognizes the thumbnails selected by checking the thumbnails composited in the scanned check sheet; and
a selected image output unit that retrieves the items of image data corresponding to the thumbnails selected by checking, and outputs the retrieved items of image data.

11. A computer readable recording medium storing the computer program as claimed in claim 10.
